(19) United States
(12) Patent Application Publication
(10) Pub. No.: US 2014/0021748 A1
(43) Pub. Date: Jan. 23, 2014

(54) Rear Package Tray Assembly

(71) Applicant: HYUNDAI MOTOR COMPANY, Seoul (KR)

(72) Inventors: Kunho Park, Yongin-si (KR); Mun Soo Cha, Hwaseong-si (KR)

(73) Assignee: Hyundai Motor Company, Seoul (KR)

(21) Appl. No.: 13/710,129

(22) Filed: Dec. 10, 2012

(30) Foreign Application Priority Data
Jul. 17, 2012 (KR) 10-2012-0077906

(51) Int. Cl. B62D 25/08

(52) U.S. Cl. CPC B62D 25/08
USPC 296/203.04

(57) ABSTRACT

The present invention relates to a rear package tray assembly, which includes: a pair of rear spring seats; a pair of roof side rails constituting a portion of an upper vehicle body; and a pair of package tray side member directly connecting the rear wheel spring seats with the roof side rails.

### CROSS-REFERENCE TO RELATED APPLICATION

The present application claims priority to Korean Patent Application No. 10-2012-0077906 filed on Jul. 17, 2012, the entire contents of which is incorporated herein for all purposes by this reference.

### BACKGROUND OF THE INVENTION

1. Field of the Invention

The present invention relates to a reinforcing structure of a rear package tray of a vehicle. More particularly, the present invention relates to a rear package tray assembly for a vehicle which can suppress vibration and improve rigidity.

2. Description of Related Art

In general, a rear package tray of a vehicle is disposed behind the rear seat, and supports the rear seat and separates the trunk room from the interior of the vehicle.

Incidentally, while a vehicle travels, the difference in load that is inputted from the left and right suspensions generates torsional moment and influences the traveling performance and the NVH.

Therefore, the torsional rigidity of the vehicle body that supports the left and right suspensions is a particularly important performance for traveling of a vehicle.

In common vehicle bodies, a spring seat through which load is inputted and roof side rails at the top of the vehicle bodies are not directly connected and separated by a package tray cross member. Therefore, there is a problem in that the load inputted to the under body of the vehicle body cannot effectively distributed to the upper body.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a rear package tray assembly having advantages of being able to suppress vibration and improve rigidity.

An exemplary embodiment of the present invention provides a rear package tray assembly, which includes, a pair of rear spring seats. a pair of roof side rails constituting a portion of an upper vehicle body. a pair of package tray side member directly connecting the rear wheel spring seats with the roof side rails.

The package tray side member may include, a lower member formed along a rear wheel housing and connected with the rear wheel spring seat. an upper member directly connected with the roof side rail.

The upper members of the package tray side members may be connected by a package tray cross member.

Both ends of the package tray cross member may be combined to cover the package tray side members.

The package tray cross member and the lower member may be connected by an inclined-reinforcing part.

The cross-sections of the package tray members taken in the longitudinal direction of the vehicle may be uniformly formed.

The cross-sections of the package tray side members taken in the transverse direction of the vehicle may be uniformly formed.

Package-outer reinforcing parts may be coupled to the joints of the roof side rails and the package tray side members.

The package tray side member and the package-outer reinforcing part may be combined to define a closed cross-section.

A quarter panel may be disposed between the package tray side member and the package-outer reinforcing part.

According to the rear package tray assembly for a vehicle of an exemplary embodiment of the present invention, it is possible to suppress vibration and noise in a vehicle by effectively distributing impact transmitted through the rear wheel seats to the upper body of the vehicle.

Further, it is possible to reduce the longitudinal widths of the package tray side members and the package tray cross member, such that it is possible to capacity of the trunk room.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a rear package tray assembly according to an exemplary embodiment of the present invention.

FIG. 2 is a front view of the rear package tray assembly according to an exemplary embodiment of the present invention.

FIG. 3 is a side view of a portion of the rear package tray assembly according to an exemplary embodiment of the present invention.

FIG. 4 is a cross-sectional view showing combination of a package tray side member and a package-outer reinforcing part in the rear package tray assembly according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

Components unrelated to the description will be omitted in order to obviously describe the present invention, and like reference numerals will be used to describe like components throughout the present specification.

Further, in the drawings, the sizes and the thicknesses of the components are exemplarily provided for the convenience of description, the present invention is not limited those shown in the drawings, and the thicknesses are exaggerated to clearly show several parts and regions.

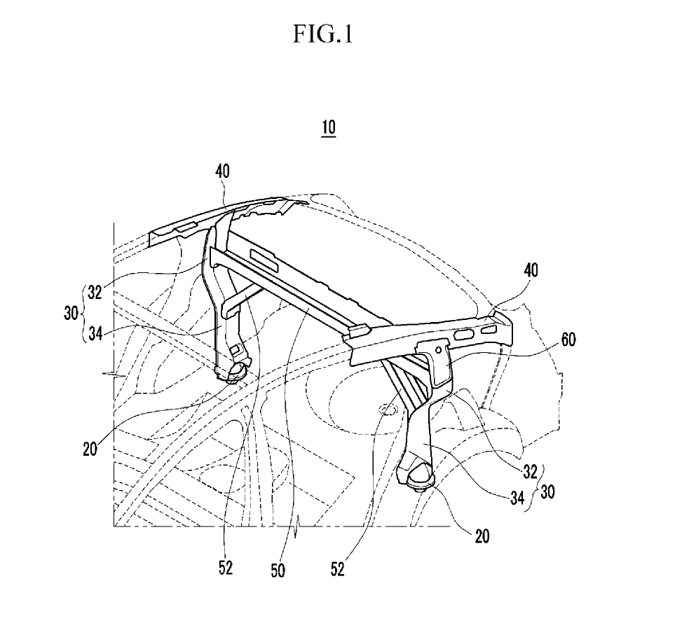

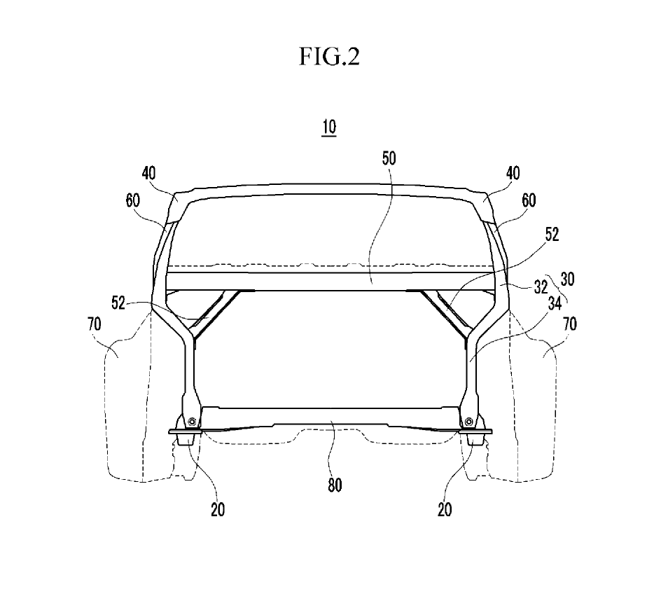

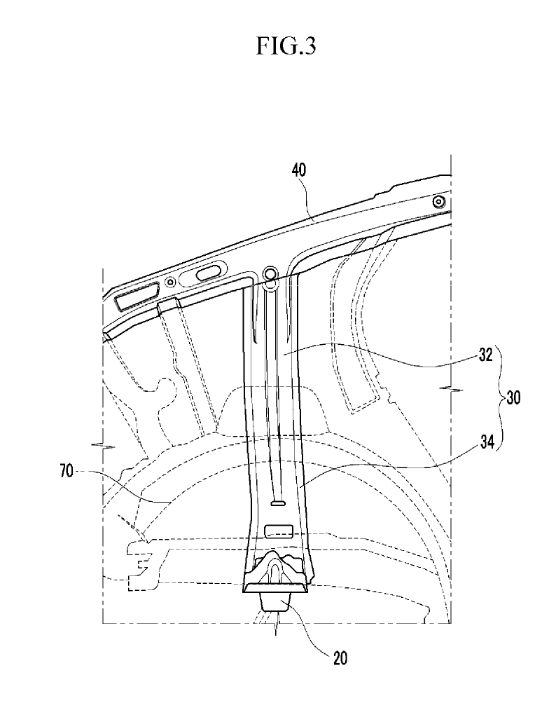

FIG. 1 is a perspective view of a rear package tray assembly according to an exemplary embodiment of the present invention, FIG. 2 is a front view of the rear package tray assembly according to an exemplary embodiment of the present invention, and FIG. 3 is a side view of a portion of the rear package tray assembly according to an exemplary embodiment of the present invention.

Referring to FIGS. 1 to 3, a rear package tray assembly 10 according to an exemplary embodiment of the present invention includes a pair of rear wheel spring seats 20, a pair of roof side rails 40 constituting a portion of the upper vehicle body, and a pair of package tray side member 30 directly connecting the rear wheel spring seats 20 with the roof side rails 40.

The rear wheel spring seats 20 receive load (impact) from the wheels and the rear wheel spring seats 20 and the roof side rails 40 are directly connected by the package tray side members 30, such that the impact transmitted to the rear wheel spring seats 20 can be directly transmitted to the roof side rails 40.

In the rear package tray assemblies of the related art, the spring seats and the roof side rails on the top of the vehicle body are not directly connected and separated by a package tray cross member. Therefore, there is a problem in that the load inputted to the under body of a vehicle is not effectively distributed to the upper body.

However, in the rear package tray assembly 10 according to an exemplary embodiment of the present invention, since the rear wheel spring seats 20 and the roof side rails 40 are directly connected by the package tray side members 30, the load inputted to the under body of the vehicle body can be effectively distributed.

The package tray side members 30 are formed along the rear wheel housing 70 and each include a lower member 34 connected with the rear wheel spring seat 20 and an upper member 32 directly connected with the roof side rail 40.

Since the package tray side members 30 are formed along the rear wheel housing 70, the package tray side members 30 can improve rigidity against torsion of the vehicle in cooperation with the rear wheel housing 70. That is, the package tray side members 30 and the rear wheel housing 70 are in close contact, such that rigidity against torsion of the vehicle can be improved.

The upper members 32 of the package tray side members 30 are connected by a package tray cross member 50, such that the package tray cross member 50 can distribute the transverse weigh of the vehicle.

Referring to FIG. 1, both ends of the package tray cross member 50 are formed to cover the package tray side members 30, such that they can be more firmly combined. Further, since the rear wheel spring seats 20 and the roof side rails 40 are not separated through the package tray cross member 50, the load inputted to the under body of the vehicle can be effectively distributed to the upper body.

The package tray cross member 50 and the lower members 34 may be connected by an inclined-reinforcing member 52 and the load of the package tray cross member 50 and the package tray side member 30 can be distributed to the inclined-reinforcing member 52.

The cross-sections of the package tray side members 30 taken in the longitudinal direction of the vehicle may be uniformly formed. That is, referring to FIG. 2, the widths of the cross-sections of the package tray side members 30 taken in the longitudinal direction of the vehicle is formed without a rapid change, such that load can be effectively distributed and the rigidity of the vehicle body can be increased.

The cross-sections of the package tray side members 30 taken in the transverse direction of the vehicle may be uniformly formed. That is, referring to FIG. 3, since a rear package tray assembly 10 according to an exemplary embodiment of the present invention can effectively distribute width, the widths of the cross-sections of the package tray side members 30 taken in the transverse direction of the vehicle can be uniformly reduced in comparison to the package tray side members of the related art, such that the capacity of the trunk room of the vehicle can be increased.

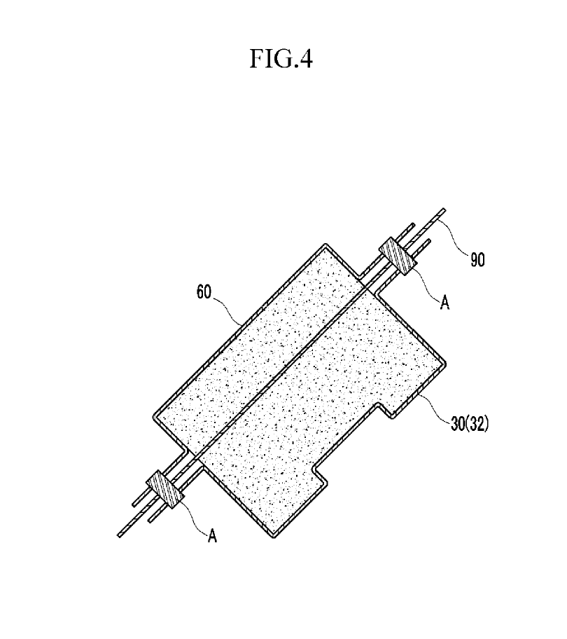

FIG. 4 is a cross-sectional view showing combination of a package tray side member and a package-outer reinforcing part in the rear package tray assembly according to an exemplary embodiment of the present invention.

Referring to FIGS. 1 and 4, package-outer reinforcing parts 60 may be coupled to the joints of the roof side rails 40 and the package tray side members 30.

The package tray side members 30 and the package-outer reinforcing parts 60 may be combined to define a closed cross-section, as shown in FIG. 4. That is, the package tray side members 30 and the package-outer reinforcing parts 60 are formed in a U-shape, such that one closed cross-section can be defined by combining the package tray side members 30 with the package-outer reinforcing parts 60. Therefore, as the package tray side members 30 and the package-outer reinforcing parts 60 are combined, the rigidity of the vehicle body can be effectively increased.

A quarter panel 90 may be disposed between the package tray side members 30 and the package-outer reinforcing parts 60. The widths of the package tray side members 30 and the package-outer reinforcing parts 60 are the same in order to define one closed cross-section, such that the number of times of welding for combination with the quarter panel 90 can be reduced.

Referring to FIG. 2, in the rear package tray assembly 10 according to an exemplary embodiment of the present invention, since the rear wheel spring seats 20 and the roof side rails 40 are directly connected by the package tray side members 30 and define one closed cross-section in cooperation with the floor panel 80 of the vehicle body, the rigidity of the vehicle body can be increased and load can be effectively distributed. Therefore, it is possible to effectively suppress NVH due to contact with the ground of the vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A rear package tray assembly in a vehicle comprising:
a pair of rear spring seats;
a pair of roof side rails forming a portion of vehicle body roof; and
a pair of package tray side members directly mounted on the rear wheel spring seats and directly connected with the roof side rails;
wherein each of the package tray side members includes:
a lower portion extending along a rear wheel housing and directly connected with a corresponding rear wheel spring seat; and
an upper portion directly connecting the lower portion and a corresponding roof side rail.

2. The rear package tray assembly of claim 1, wherein both distal ends of a package tray cross member are formed to cover the package tray side members.

3. (canceled)

4. The rear package tray assembly of claim 1, wherein the lower member is formed along an inner surface of the rear wheel housing.

5. The rear package tray assembly of claim 1, wherein each upper member of the package tray side members is connected to a package tray cross member disposed in a traverse direction of the vehicle.

6. The rear package tray assembly of claim 5, wherein the package tray cross member and each lower member are connected by an inclined-reinforcing part.

7. The rear package tray assembly of claim 1, wherein a package-outer reinforcing part is coupled to a joint of each roof side rail and each upper member of the package tray side members.

8. (canceled)

9. The rear package tray assembly of claim 1, wherein each of the package tray side members and each of the package-outer reinforcing parts are combined to define a closed cross-section.

10. The rear package tray assembly of claim 9, wherein a quarter panel is disposed between the package tray side members and the package-outer reinforcing parts.

11. The rear package tray assembly of claim 1, wherein cross-sections of the package tray side members taken in a longitudinal direction of the vehicle are uniformly formed.

12. The rear package tray assembly of claim 1, wherein cross-sections of the package tray side members taken in a transverse direction of the vehicle are uniformly formed.

13. The rear package tray assembly of claim 1, wherein the pair of rear spring seats is mounted directly onto a floor panel.
